(19) United States
(12) Patent Application Publication
(10) Pub. No.: US 2001/0047707 A1
(43) Pub. Date: Dec. 6, 2001

(54) Pipe cutting machine

(76) Inventors: Andreas Grewe, Menden (DE); Hartwig Hiestermann, Iserlohn (DE); Michael Otto, Iserlohn (DE)

Correspondence Address: John R. Flanagan, FLANAGAN & FLANAGAN, P.O. Box 11300, Jackson Hole, WY, 83002, US

(21) Appl. No.: 09/819,567

(22) Filed: Mar. 27, 2001

(30) Foreign Application Priority Data
May 28, 2000 (DE) 100 15 367.4-14

(51) Int. Cl. B26D 3/16

(52) U.S. Cl. 83/453; 83/452; 83/456

(57) ABSTRACT

A pipe cutting machine includes a frame, a cutting blade mounted on the frame and movable in a predetermined direction for cutting apart a pipe and at least one clamping fitting having clamping jaws for clamping the pipe to be cut by the cutting blade. The clamping fitting is positioned obliquely with respect to the frame and to the direction of movement of a tip on the cutting blade such that clamping gaps defined by clamping jaws of the clamping fitting are angularly displaced from an exit point of the blade tip on the pipe and thereby one of the clamping jaws provides a backing abutment for the pipe disposed adjacent to the exit point of the blade tip so that impingement of the blade tip on the pipe at the exit point will not produce deformation of the pipe.

### BACKGROUND OF THE INVENTION

1. Field of the Invention

The present invention relates to pipe cutting machines and, more particularly, is concerned with a pipe cutting machine having a cutting blade tip and pipe clamping jaws defining a clamping gap angularly displaced from an exit point of the blade tip on the pipe such that one clamping jaw provides a backing abutment for the pipe adjacent to the exit point of the blade tip on the pipe.

2. Description of the Prior Art

Pipe cutting machines are employed which, from a relatively longer pipe, can form shorter pipe sections that are cut-to-fit with respect to their lengths. For example, a pipe cutting machine is disposed at an end of a pipe welding installation for producing longitudinal seam-welded pipes.

German patent document No. DE 36 41 886 A1 discloses a pipe cutting machine of the above-described type. This prior art pipe cutting machine comprises a cutting device with a machine-driven pipe-cutting blade movable in the vertical direction for cutting apart the pipe. The cutting edge of the blade includes a point or tip and a pair of opposite side portions located on respective opposite sides of the tip. The opposite side portions extend concavely outward and upward in opposite directions away from the tip such that the tip leads the opposite side portions as the blade moves downward in the vertical direction toward the pipe. The prior art pipe cutting machine further comprises a clamping device for clamping the pipe to be cut. The clamping device comprises two clamping fittings displaced from one another axially along the pipe to be cut so as to provide a relatively small spacing therebetween defining a narrow cutting gap into which the blade can move for cutting the pipe. Each clamping fitting includes a pair of clamping jaws which are disposed such that they are movable in a known clamping direction toward and away from each other in a horizontal plane and provide a clamping plane extending at a right angle to the clamping direction and aligned with the tip of the blade along and relative to the direction of movement of the blade. The prior art pipe cutting machine still further comprises a transverse blade extending into the cutting gap between the clamping fittings and with which an upper side of the pipe is scored or incised before the blade with its cutting edge is moved into the cutting gap in order to cut the pipe to divide the pipe completely. Such pipe cutting machine is preferably employed wherever rapid cutting- or precutting-to-fit of pipe sections is critical, such as, for example, at the end of the pipe welding installation with which longitudinal seam-welded pipes are produced.

However during the carrying out of the pipe cutting process for separating a pipe section using such pipe cutting machine, an outwardly protruding bead-like deformation of the pipe is produced in the region of the underside of the pipe opposite from where the tip of the blade penetrates through the pipe underside. The reason why this bead-like deformation of the pipe underside occurs is because the blade tip, in penetrating through the underside of the pipe, unavoidably impinges on an interior or inner surface of the pipe where the pipe has not been scored or incised before impingement by the blade tip, unlike the upper outer pipe surface that was scored or incised by the transverse blade. Due to the unavoidable deformation of the ends of the cut-off pipe sections, depending upon the intended application of the pipe section the deformed ends frequently have to be sawed off subsequent to the pipe cutting process. Apart from the disadvantage of the substantially longer time required for cutting apart pipe section when the deformed ends then have to be sawed off, there is a further disadvantage that the front faces of the pipe sections exhibit traces of sawing and sawdust is frequently found within the pipe sections which, if necessary, must additionally be removed from the pipe sections.

To avoid the problem of deformation of the underside of the pipe when using a single cutting blade, German patent document No. DE 44 21 811 C2 discloses a pipe cutting machine in which, instead of a single cutting blade, two cutting blades are used, being disposed diametrically opposite one another. Accordingly, this pipe cutting machine also comprises a transverse blade associated with each cutting blade for scoring and cutting open the upper side of outer side of the particular pipe in order to make possible the penetration of the blade point or tip into the interior of the pipe. While this pipe cutting machine avoids producing a deformation on the underside of the pipe since it is split apart like the upper side of the pipe, considerable additional machine expenditures are required in order to drive the two blades with the corresponding timing. Moreover, it is necessary to dispose the two cutting blades such that they are precisely aligned with one another in their plane in order to attain a smooth cutting result. Such adjustment, however, is expensive and complicated since the guidance mechanics for guiding and driving the cutting blades must be included in this adjustment.

Consequently, there is a need for further development of the pipe cutting machine of the type disclosed in German patent document No. DE 36 41 886 A1 having the single cutting blade, such that separation of a desired pipe section is possible without producing the deformation on the underside of the pipe section and without having to increase machinery expenditures.

### SUMMARY OF THE INVENTION

The present invention overcomes the aforementioned problems at an exit point on a pipe of a tip of a single pipe cutting blade of a pipe cutting machine by angularly displacing from the exit point a clamping gap defined between pipe clamping jaws of a clamping fitting of the pipe cutting machine such that one clamping jaw is thereby positioned as a backing abutment for the pipe adjacent to the exit point. Then, impingement by the blade tip at the exit point on an unscored interior surface of the pipe, opposite from the backing abutment provided by the one clamping jaw adjacent to the exterior surface of the pipe, will now not produce deformation at the exterior surface of the pipe due to the lack of enough space between the backing abutment and exterior surface of the pipe. In this manner, deformation-free cutting off of pipe sections is possible even without having to precut or score the interior surface of the pipe at the exit point thereon in order to prevent the deformation.

Accordingly, the present invention is directed to a pipe cutting machine which comprises: (a) a cutting blade movable in a predetermined direction for cutting apart a pipe, the cutting blade having a cutting tip which is moved from an entry point to an exit point on the pipe with the movement of the cutting blade in the predetermined direction relative to the pipe for cutting apart the pipe; and (b) at least one clamping fitting for clamping the pipe to be cut by the cutting blade, the clamping fitting having at least two clamping jaws movable toward and away from each other so as to provide a clamping plane therebetween and define clamping gaps between the clamping jaws disposed along the clamping plane, the clamping fitting being positioned relative to the cutting blade such that each of the clamping gaps defined along the clamping plane is angularly displaced, such as at an oblique angle, from the exit point of the blade tip on the pipe and thereby one of the clamping jaws provides an abutment for the pipe disposed adjacent to the exit point of the blade tip so that impingement of the blade tip on the pipe at the exit point will not produce a deformation of the pipe.

Also, each clamping fitting of the pipe cutting machine of the present invention can have more than two clamping jaws, for example three or four. The clamping jaws can be movable in radial directions in the formation of a star. In any event, it is essential that, in the region of the exit point of the cutting blade tip, one of the clamping jaws of each clamping fitting provides the backing abutment, and not a clamping gap, at such exit point that is aligned with the path of movement of the blade tip.

The positioning of the clamping gap at the oblique angle to the direction of movement of the cutting blade and thus to the exit point of the cutting blade tip can be realized in a simple manner, for example, by positioning means disposing the clamping fitting obliquely with respect to the cutting blade and a frame of the pipe cutting machine movably mounting the cutting blade.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1a is an end elevational view of a pipe cutting machine according to the present invention having a pipe cutting blade with a tip and at least two pipe clamping jaws defining a clamping gap therebetween angularly displaced from or at an oblique angle to the direction of movement of the pipe-cutting blade tip at an exit point of the blade tip on the pipe.

FIG. 1b is an enlarged detailed view of the portion of the pipe cutting machine encompassed within circle A of FIG. 1a.

FIG. 2 is a schematic representation of the cutting blade and clamping jaws of one clamping fitting of the pipe cutting machine of the present invention of FIG. 1 showing the cutting blade tip misaligned with the clamping gaps between the clamping jaws.

FIG. 2a is a schematic representation of the clamping fittings of the pipe cutting machine seen along line 2a-2a of FIG. 2 showing a narrow cutting gap between the clamping fittings into which the blade moves for cutting the pipe.

FIG. 3 is a schematic representation of the cutting blade and clamping jaws of one clamping fitting of the prior art pipe cutting machine, showing the cutting blade tip aligned with the clamping gaps between the clamping jaws.

FIG. 4 is a schematic representation similar to that of FIG. 2, but showing a clamping fitting having three clamping jaws wherein none of the clamping gaps defined between the clamping jaws is aligned with the exit point of the blade tip on the underside of the pipe.

### DETAILED DESCRIPTION OF THE INVENTION

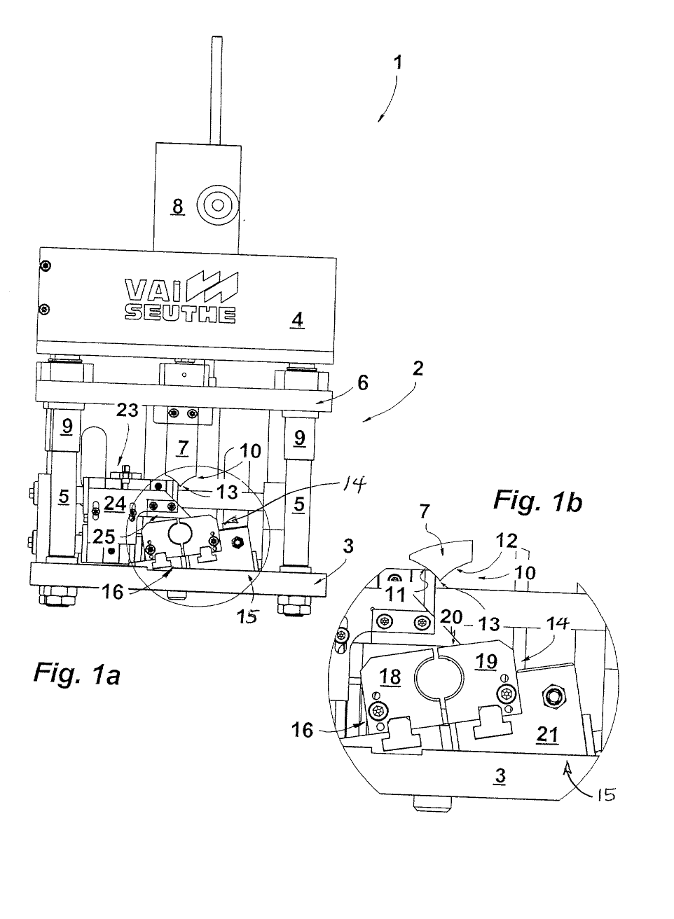

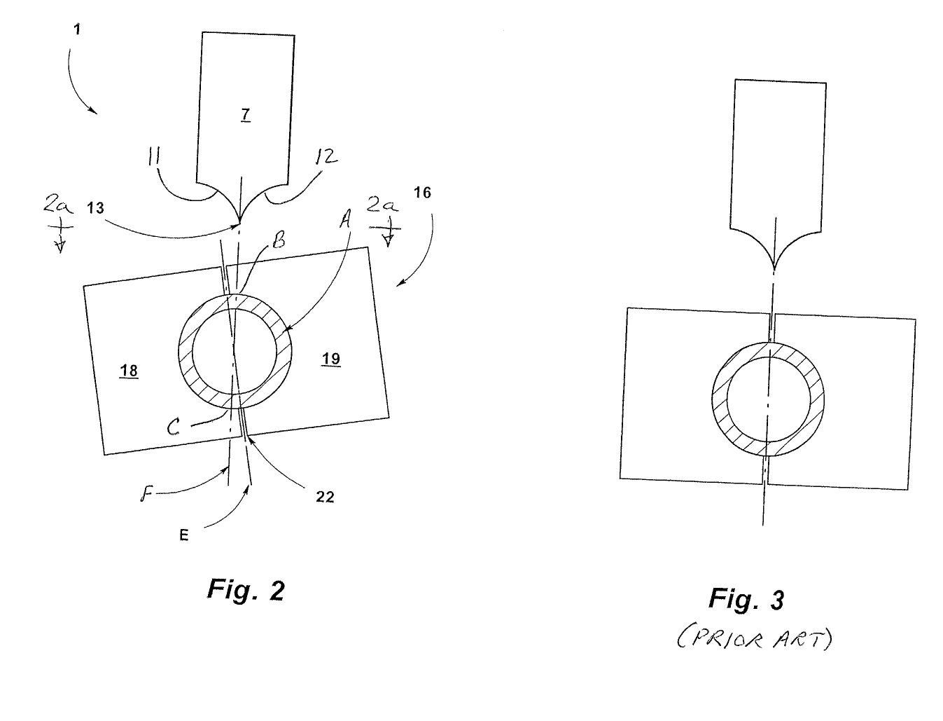

Referring to the drawings and particularly to FIGS. 1a and 1b, there is illustrated a pipe cutting machine of the present invention, being generally designated 1. The pipe cutting machine 1 basically includes a frame 2, a cutting blade 7 mounted on the frame 2 having a point or tip 13 and movable in a predetermined direction for cutting apart a pipe A (FIG. 2), and at least one and preferably a clamping device 14 mounted on the frame 2 for clamping the pipe A to be cut by the cutting blade 7. Also, the machine 1 can include a positioning mechanism 15 such as a chock 21 for disposing the clamping device 14 obliquely or in an inclined orientation with respect to the frame 2 and to the direction of movement of the cutting blade tip 13.

The frame 2 is formed essentially of a base plate 3, an upper plate 4 and four guidance columns 5 which supported the upper plate 4 above the base plate 3. Also, guided by the guidance columns 5 is a cutting plate 6 disposed below the upper plate 4 and from which cutting plate 6 is mounted the cutting blade 7 so as to project downwardly therefrom. The cutting plate 6 is engaged by a driving device 8 which can move the cutting plate 6, and thus the cutting blade 7, downwardly in the vertical direction. For this purpose, the cutting plate 6 is guided on the guidance columns 5 via sleeves 9.

Referring to FIGS. 1a, 1b and 2, the cutting blade 7 has a lower cutting edge 10 which includes the aforementioned tip 13, preferably located in the geometric center of the cutting edge 10, and a pair of opposite side portions 11, 12 located on respective opposite sides of the tip 13. The opposite side portions 11, 12 of the cutting edge 10, being substantially mirror images of one another, may extend concavely outward and rearward, or arcuately, in opposite directions away from the tip 13 such that the tip 13 will lead the opposite side portions 11, 12 as the tip 13 is moved downward from an entry point B to an exit point C on the pipe A with movement of the cutting blade 7 in the predetermined vertical direction relative to the pipe A for cutting apart the pipe A.

Referring to FIGS. 1a, 1b, 2 and 2a, the pipe A is retained clamped in the desired position by the clamping device 14. In the clamped condition the upper apex of the pipe A is aligned in the direction of movement of the blade 7 beneath the tip 13 thereof. More particularly, the clamping device 14 comprises at least one and preferably a pair of clamping fittings 16, 17. Each of the clamping fittings 16, 17, in the embodiment illustrated in FIGS. 1a, 1b, 2 and 2a, has two clamping jaws 18, 19 individually cooperating with one another to clamp the pipe A between them and also to define a clamping gap 22 therebetween. In FIGS. 1a and 1b for the sake of clarity only the clamping jaws 18, 19 of the front clamping fitting 16 are labeled with reference symbols. In FIG. 2a, it can be seen that the clamping fittings 16, 17 are spaced apart a small distance from one another axially along the pipe A so as to leave between them a narrow cutting gap 20 through which the cutting blade 7 can pass for cutting off from the pipe A a shorter pipe section D extending in a given direction from of the clamping fittings 16, 17.

As seen in FIGS. 1a and 1b, the chock 21 of the pipe cutting machine 1 disposes the clamping fittings 16, 17 of the clamping device 14 obliquely or in the inclined orientation with respect to the horizontal alignment of the base plate 3 of the frame 1 and also to the vertical direction of movement of the cutting blade tip 13. As a result of this oblique disposition of the chock 21, the plane E of the clamping gap 22, necessarily remaining between the clamping jaws 18, 19, is inclined with respect to the direction of movement of the cutting blade 7 such that aligned underneath the tip 13 of the cutting blade 7 on the exterior surface of the pipe A is a lower portion of the one clamping jaw 18 so as to serve as a backing abutment for the exit point C of the blade tip 13 on the pipe A. It should be understood that the chock 21 may be omitted with the clamping device 14 being mounted directly to the frame 2.

For clarification, this disposition of the clamping jaws 18, 19 with the lower clamping gap 22 is schematically depicted in FIG. 2. The vertical axis of motion of the blade 7 is shown in a dot-dash line labeled with the reference symbol F. In the representation of FIG. 2, it is evident that the path of motion F of the blade tip 13 when penetrating into the underside of the pipe A at the exit point C encounters the backing abutment formed by the lower portion of the clamping jaw 18 such that deformation of the two pipe sections D being separated from one another is prevented. In FIG. 2, it can be seen that the clamping gaps 22 defined by clamping jaws 18, 19 are angularly displaced from the exit point C of the blade tip 13 on the pipe A and thereby the one clamping jaw 18 necessarily provides the aforementioned backing abutment for the pipe A adjacent to the exit point C of the blade tip 13 so that impingement of the blade tip 13 on the pipe A at the exit point C will not produce deformation of the pipe A.

For a comparison of the principle realized by the subject matter of the present invention with the known prior art, a schematic representation of the pipe cutting machine according to the prior art is reproduced in FIG. 3. The representation shows the aligned disposition of the plane of the clamping gap with the line of movement F of the blade tip 13.

The pipe cutting machine 1 further includes a scoring device 23 having a carrier 24 mounted on the base plate 3 and supporting a hook-shaped scoring blade 25 for undergoing displacement transversely to the direction of movement of the blade 7. The scoring blade 25 serves for incising the upper surface of the pipe A before the cutting-off proper of the pipe section D by the cutting blade 7 takes place. This preliminary incising of the upper surface of the pipe A serves for preventing deformations which otherwise would occur when the blade tip 13 impinges on the apex surface of the pipe A.

In the embodiment of FIGS. 1a, 1b and 2, the clamping device 14 is force-guided and machine driven such that the clamping and releasing of the pipe A by the clamping jaws 18. 19 takes place in the working cycle of the pipe cutting machine 1.

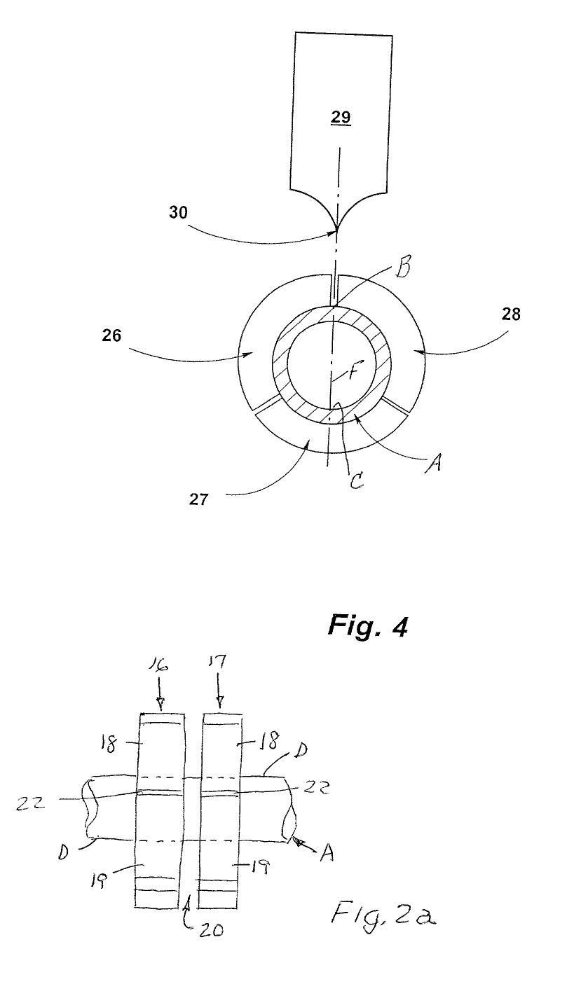

FIG. 4 shows schematically a further embodiment of the pipe cutting machine in which, in contrast to the embodiment of FIGS. 1a, 1b and 2, each of the clamping fittings 16, 17 includes three clamping jaws 26-28 which can be radially moved apart from one another in the form of a star. In this embodiment it is also evident due to the disposition of the clamping jaw 27 that in the alignment of the path of movement of blade 29, in particular its point or tip 30, there is no clamping gap on the underside of the pipe A at the exit point of the blade tip on the pipe A such that in this embodiment pipe deformation, such as occurs in the case of the prior art, also does not take place.

Based on the foregoing description of the present invention it becomes evident that with simple means the prior art pipe cutting machine can be provided or also retrofitted in order for a clean pipe sectioning to take place with it, without the necessity of having to carry out expensive postworking of the pipe sections.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

We claim:

1. A pipe cutting machine, comprising:
(a) a cutting blade movable in a predetermined direction for cutting apart a pipe, said cutting blade having a cutting tip which is moved from an entry point to an exit point on the pipe with movement of said cutting blade in said predetermined direction relative to the pipe for cutting apart the pipe; and
(b) at least one clamping fitting for clamping the pipe to be cut by said cutting blade, said clamping fitting having at least two clamping jaws movable toward and away from each other so as to provide a clamping plane and define clamping gaps between said clamping jaws disposed along said clamping plane, said clamping fitting being positioned relative to said cutting blade such that each of said clamping gaps defined along said clamping plane is angularly displaced from the exit point of said blade tip on the pipe and thereby one of said clamping jaws provides a backing abutment for the pipe disposed adjacent to the exit point of said blade tip so that impingement of said blade tip on the pipe at the exit point will not produce deformation of the pipe.

2. The machine as claimed in claim 1, wherein said clamping fitting has more than two clamping jaws and said positioning means disposes one of said clamping jaws relative to the exit point of the blade tip so as to provide said backing abutment for the pipe adjacent to the exit point of the blade tip.

3. The machine as claimed in claim 1, wherein said clamping fitting has two clamping jaws and said positioning means disposes said clamping jaws of said clamping fitting such that said clamping gaps are disposed along said clamping plane at an oblique angle to said direction of movement of said cutting blade and thus angularly displaced from said exit point of said cutting blade on the pipe.

4. The machine as claimed in claim 1, said clamping device includes a pair of said clamping fittings displaced from one another axially along the pipe to be cut so as to provide spacing therebetween defining a cutting gap into which said cutting blade is moved for cutting the pipe.

5. A pipe cutting machine, comprising:
(a) a cutting blade movable in a predetermined direction for cutting apart a pipe, said cutting blade having a cutting edge which includes a tip and a pair of opposite side portions located on respective opposite sides of said tip, said opposite side portions extending outward and rearward in opposite directions away from said tip such that said tip will lead said opposite side portions as said tip is moved from an entry point to an exit point on the pipe with movement of said cutting blade in said predetermined direction relative to the pipe for cutting apart the pipe; and
(b) a pair of clamping fittings displaced from one another axially along the pipe to be cut so as to provide spacing therebetween defining a cutting gap into which said cutting blade is moved for cutting the pipe, each of said clamping fittings including at least two clamping jaws movable toward and away from each other so as to provide a clamping plane and define clamping gaps between said clamping jaws disposed along said clamping plane, each of said clamping fittings being positioned relative to said cutting blade such that each of said clamping gaps defined along said clamping plane is angularly displaced from the exit point of said blade tip on the pipe and thereby one of said clamping jaws provides a backing abutment for the pipe disposed adjacent to the exit point of said blade tip so that impingement of said blade tip on the pipe at the exit point will not produce deformation of the pipe.

6. The machine as claimed in claim 5, wherein said each of said clamping fittings has more than two clamping jaws and said positioning means disposes one of said clamping jaws of each of said clamping fittings relative to the exit point of the blade tip so as to provide said backing abutment for the pipe disposed adjacent to the exit point of the blade tip.

7. The machine as claimed in claim 5, wherein each of said clamping fittings has two clamping jaws and said positioning means disposes said clamping jaws of each of said clamping fittings such that said clamping gaps are disposed along said clamping plane at an oblique angle to said direction of movement of said cutting blade and thus angularly displaced from said exit point of said cutting blade on the pipe.

8. A pipe cutting machine, comprising:
(a) a frame;
(b) a cutting blade mounted on said frame and movable in a predetermined direction for cutting apart a pipe;
(c) at least one clamping fitting having clamping jaws for clamping the pipe to be cut by said cutting blade; and
(d) a positioning mechanism disposing the clamping fitting obliquely with respect to said frame and to said direction of movement of a tip on said cutting blade such that clamping gaps defined by said clamping jaws of said clamping fitting are angularly displaced from an exit point of said blade tip on the pipe and thereby one of said clamping jaws provides a backing abutment for the pipe disposed adjacent to the exit point of said blade tip so that impingement of said blade tip on the pipe at the exit point will not produce deformation of the pipe.
